(19) United States
(12) Patent Application Publication
(10) Pub. No.: US 2026/0148900 A1
(43) Pub. Date: May 28, 2026

(54) MULTILAYER CERAMIC CAPACITOR

(71) Applicant: Murata Manufacturing Co., Ltd., Nagaokakyo-shi (JP)

(72) Inventors: Kazuhiro NISHIBAYASHI, Nagaokakyo-shi (JP); Takashi SAWADA, Nagaokakyo-shi (JP)

(21) Appl. No.: 19/453,646

(22) Filed: Jan. 20, 2026

Related U.S. Application Data
(63) Continuation of application No. PCT/JP2024/023950, filed on Jul. 2, 2024.

(30) Foreign Application Priority Data
Aug. 2, 2023 (JP) 2023-126521

(51) Int. Cl. H01G 4/232; H01G 4/008; H01G 4/012; H01G 4/12; H01G 4/224; H01G 4/30

(52) U.S. Cl. CPC H01G 4/2325; H01G 4/008; H01G 4/012; H01G 4/1227; H01G 4/224; H01G 4/30

(57) ABSTRACT

A multilayer ceramic capacitor includes a multilayer body including an inner layer portion in which dielectric layers and internal electrodes are alternately stacked and outer layer portions on both sides of the inner layer portion in a stacking direction, and external electrodes on at least one surface of the multilayer body in a direction intersecting the stacking direction and including main-surface-side folded-back sections and covering a portion of the outer layer portions. A mixture layer of a dielectric and a metal is provided in covered sections of the outer layer portions covered by the main-surface-side folded-back sections.

### CROSS REFERENCE TO RELATED APPLICATIONS

This application claims the benefit of priority to Japanese Patent Application No. 2023-126521 filed on Aug. 2, 2023 and is a Continuation Application of PCT Application No. PCT/JP2024/023950 filed on Jul. 2, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Recently, reduction in impedance of electronic circuit lines has become important, particularly for mobile device products. For the purpose of reducing impedance of electronic circuit lines, three-terminal multilayer ceramic capacitors for decoupling applications are widely used.

A three-terminal multilayer ceramic capacitor includes a multilayer body including an inner layer portion in which dielectric layers including end surface exposed internal electrodes exposed at end surfaces and dielectric layers including lateral surface internal electrodes exposed at lateral surfaces are alternately laminated in multiple layers, and outer layer portions provided on one side and the other side of the inner layer portion in the lamination direction, and external electrodes including end surface external electrodes provided at the end surfaces and connected to the end surface exposed internal electrodes, and lateral surface external electrodes provided at the lateral surfaces and connected to the lateral surface internal electrodes (see, for example, Japanese Unexamined Patent Application Publication No. 2013-201417).

Reduction in size of the three-terminal multilayer ceramic capacitor enables further reduction of impedance in high-frequency characteristics. The impedance reduction resulting from reduction in size derives from a decrease in the Equivalent Series Inductance (hereinafter referred to as “ESL”) possessed by the multilayer ceramic capacitor.

However, when a multilayer ceramic capacitor is reduced in size, the contact area between the external electrodes and the internal electrodes becomes smaller. Therefore, the adhesive force of the external electrodes to the multilayer body decreases, and the external electrodes are likely to peel off from the multilayer body.

### SUMMARY OF THE INVENTION

Example embodiments of the present invention provide multilayer ceramic capacitors in each of which external electrodes are unlikely to peel off from the multilayer body.

A multilayer ceramic capacitor according to an example embodiment of the present invention includes a multilayer body including an inner layer portion in which a plurality of dielectric layers and a plurality of internal electrodes are alternately laminated, and outer layer portions each on a corresponding one of opposite sides of the inner layer portion in a lamination direction, and external electrodes each including a main surface-side folded portion on at least one surface of the multilayer body in a direction intersecting the lamination direction and covering a portion of a corresponding one of the outer layer portions. A mixed layer of a dielectric and a metal is provided in a covered portion of each of the outer layer portions covered by the main surface-side folded portion.

According to example embodiments of the present invention, multilayer ceramic capacitors in each of which external electrodes are unlikely to peel off from the multilayer body are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to an example embodiment of the present invention.

FIG. 2 is a cross-sectional view of the multilayer ceramic capacitor 1 taken along the II-II direction in FIG. 1.

FIG. 3 is a cross-sectional view of the multilayer ceramic capacitor 1 taken along the III-III direction in FIG. 1.

FIG. 4 is a cross-sectional view along an end surface exposed internal electrode 15A of a multilayer ceramic capacitor 1 according to an example embodiment of the present invention.

FIG. 5 is a cross-sectional view along a lateral surface exposed internal electrode 15B of a multilayer ceramic capacitor 1 according to an example embodiment of the present invention.

FIG. 6 is a cross-sectional view of an outer layer portion 12 of the multilayer ceramic capacitor 1 taken along the IV-IV direction in FIG. 1.

FIG. 7 is a diagram explaining an example of a manufacturing process of a multilayer body 2 in a method of manufacturing the multilayer ceramic capacitor 1 according to an example embodiment of the present invention.

FIG. 8 is a flowchart explaining an example of a method of manufacturing a multilayer ceramic capacitor 1 according to an example embodiment of the present invention.

### DETAILED DESCRIPTION OF THE EXAMPLE EMBODIMENTS

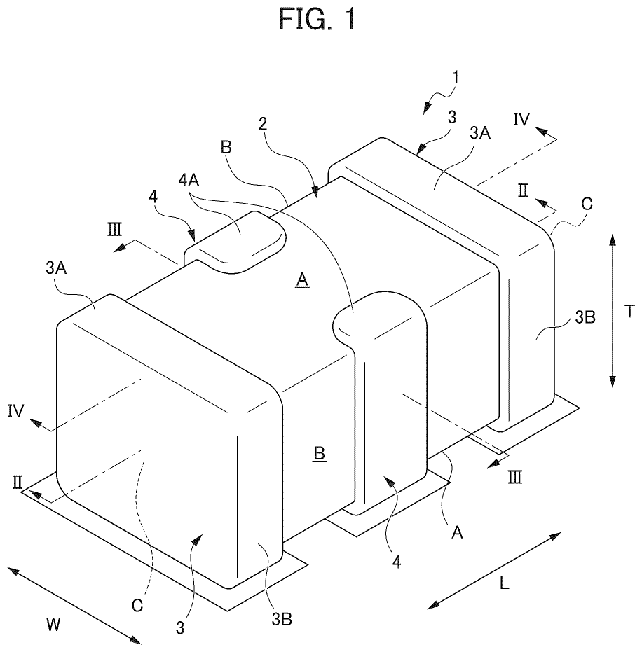

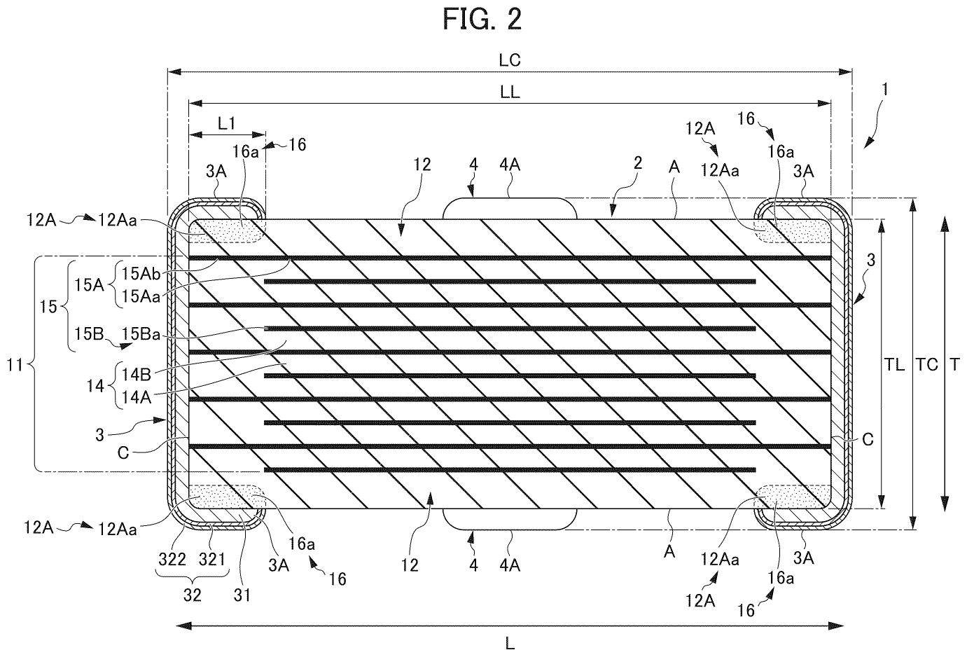

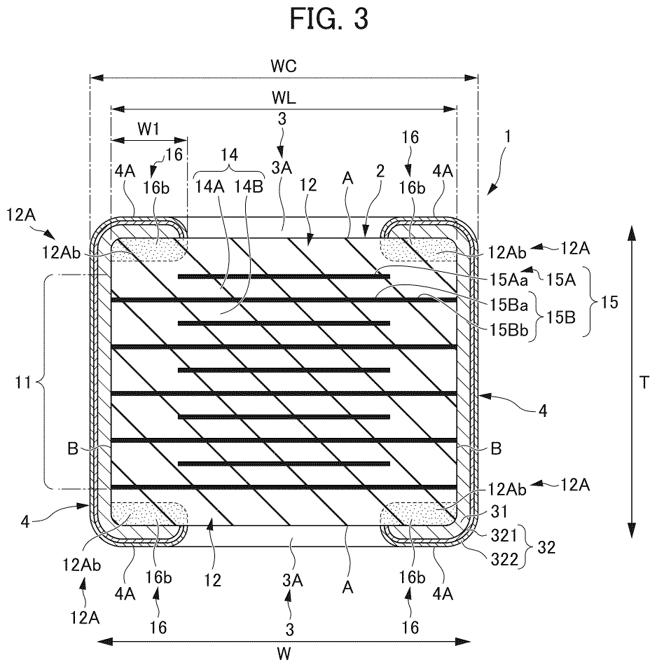

Hereinafter, multilayer ceramic capacitors according to example embodiments of the present invention will be described. FIG. 1 is a schematic perspective view of a multilayer ceramic capacitor 1 according to an example embodiment of the present invention. FIG. 2 is a cross-sectional view of the multilayer ceramic capacitor 1 taken along the II-II direction in FIG. 1. FIG. 3 is a cross-sectional view of the multilayer ceramic capacitor 1 taken along the III-III direction in FIG. 1.

The multilayer ceramic capacitor 1 is a three-terminal multilayer ceramic capacitor 1 including a multilayer body 2, end surface external electrodes 3 provided on both end surfaces C in the length direction L of the multilayer body 2, and lateral surface external electrodes 4 provided on both lateral surfaces B in the width direction W of the multilayer body 2. The multilayer body 2 includes an inner layer portion 11 in which dielectric layers 14 and internal electrodes 15 are laminated, and outer layer portions 12.

In the present specification, as terms representing the orientation of the multilayer ceramic capacitor 1, the direction in which the dielectric layers 14 and the internal electrodes 15 are laminated in the multilayer ceramic capacitor 1 is defined as the lamination direction T. The direction intersecting the lamination direction T and in which the pair of end surface external electrodes 3 are provided is defined as the length direction L. The direction intersecting both the length direction L and the lamination direction T is defined as the width direction W. In the example embodiments, the lamination direction T, the length direction L, and the width direction W are orthogonal or substantially orthogonal to each other.

In the following description, among the six outer surfaces of the multilayer body 2, a pair of outer surfaces provided on both sides in the lamination direction T are defined as main surfaces A, a pair of outer surfaces extending in the lamination direction T and provided on both sides in the width direction W are defined as lateral surfaces B, and a pair of outer surfaces extending in the lamination direction T and provided on both sides in the length direction L are defined as end surfaces C.

The multilayer ceramic capacitor 1 shown in FIG. 2 or FIG. 3 has, for example, a dimension LC in the length direction L of about 0.10 mm or more and about 0.70 mm or less, a dimension WC in the width direction W of about 0.05 mm or more and about 0.40 mm or less, and a dimension TC in the lamination direction T of about 0.10 mm or more and about 0.55 mm or less.

Furthermore, for example, the capacitance of the multilayer ceramic capacitor 1 is about 0.022 μF or more and about 10 μF or less, and preferably about 1.0 μF or more and about 2.2 μF or less. The ESL of the multilayer ceramic capacitor 1 is, for example, about 65 pH or less at about 100 MHz, and preferably about 50 pH or less at about 1 GHz.

The capacitance of the multilayer ceramic capacitor 1 can be obtained using, for example, an LCR meter (available from Agilent Technologies, model number: E4980A) under conditions of about 1 kHz and about 0.5 Vrms. The ESL of the multilayer ceramic capacitor 1 can be obtained by, for example, calculation from measured values of impedance at a predetermined frequency using a network analyzer (available from Agilent Technologies, model number: E5080A).

The multilayer body 2 includes an inner layer portion 11 and outer layer portions 12 provided on both sides of the inner layer portion 11 in the lamination direction T. It is preferable that the multilayer body 2 includes rounded corner portions and ridge portions. The corner portions refer to portions where three surfaces of the multilayer body 2 intersect, and the ridge portions refer to portions where two surfaces of the multilayer body 2 intersect.

The dimensions of the multilayer body 2 shown in FIG. 2 or FIG. 3 are as follows: the dimension LL in the length direction L is about 0.09 mm or more and about 0.69 mm or less, the dimension WL in the width direction W is about 0.04 mm or more and about 0.39 mm or less, and the dimension TL in the lamination direction T is about 0.09 mm or more and about 0.54 mm or less.

The inner layer portion 11 includes a plurality of dielectric layers 14 and a plurality of internal electrodes 15 laminated along the lamination direction T.

The dielectric layers 14 are each made of a ceramic material. As the ceramic material, for example, a ceramic material including as a main component a ceramic material including at least one of Ca, Zr, and Ti may be used. Specifically, for example, a ceramic material having a perovskite structure represented by a general formula ABO₃ including Ca and Zr may be used as a main component. Examples of such ceramic materials having a perovskite structure include, but are not limited to, BaTiO₃ (barium titanate) and CaZrO₃ (calcium zirconate). Further, the main component of the ceramic material of the dielectric layers 14 may include all of Ca, Zr, and Ti.

The internal electrodes 15 are each preferably made of a metal material such as, for example, Ni, Cu, Ag, Pd, Ag—Pd alloy, Au, or the like.

The internal electrodes 15 include a plurality of end surface exposed internal electrodes 15A and a plurality of lateral surface exposed internal electrodes 15B that are alternately provided. When it is not necessary to particularly distinguish between the end surface exposed internal electrodes 15A and the lateral surface exposed internal electrodes 15B, they are collectively described as internal electrodes 15.

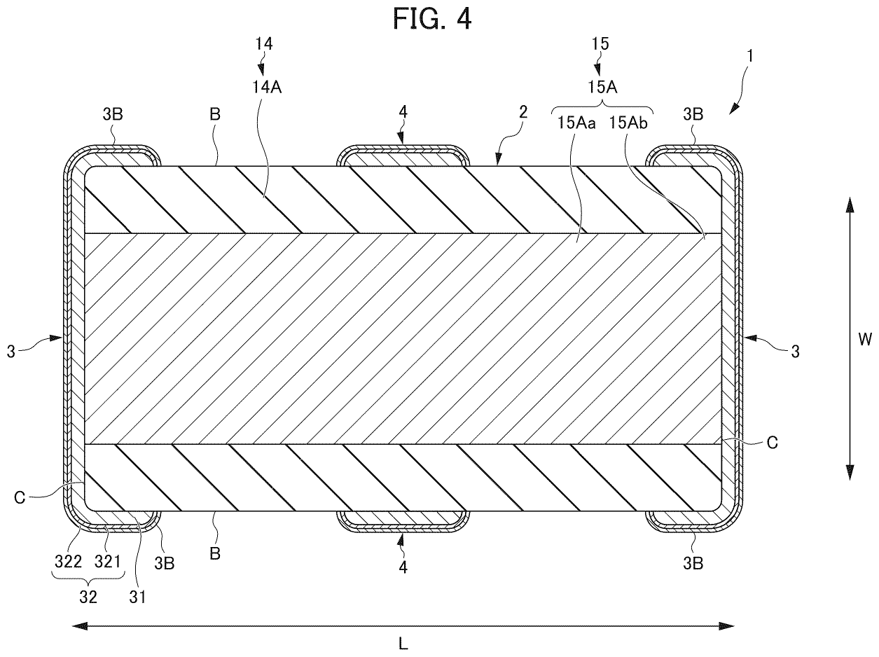

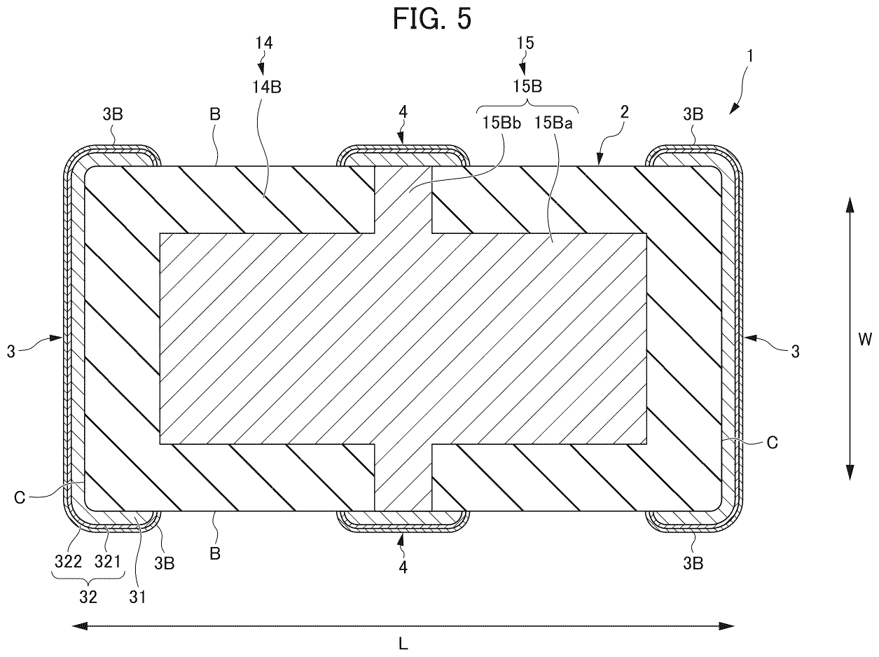

FIG. 4 is a cross-sectional view along the end surface exposed internal electrodes 15A of the multilayer ceramic capacitor 1. FIG. 5 is a cross-sectional view along the lateral surface exposed internal electrodes 15B of the multilayer ceramic capacitor 1.

As shown in FIG. 4, the end surface exposed internal electrode 15A extends between both end surfaces C in the length direction L of the multilayer body 2 and is spaced apart from both lateral surfaces B in the width direction W by a fixed distance. The end surface exposed internal electrode 15A includes an end surface counter portion 15Aa located in the middle portion between both end surfaces C, and end surface extension portions 15Ab extending from the end surface counter portion 15Aa toward both end surfaces C. In the example embodiments, the end surface counter portion 15Aa and the end surface extension portions 15Ab have equal or substantially equal dimensions in the width direction W, and the end surface exposed internal electrode 15A is rectangular or substantially rectangular as a whole combining the end surface counter portion 15Aa and the end surface extension portions 15Ab. The end surface extension portions 15Ab extending from the end surface counter portion 15Aa toward both end surfaces C each extend toward both end surfaces C and are exposed at the end surfaces C of the multilayer body 2, and are connected to the end surface external electrodes 3 provided on both end surfaces C in the length direction L of the multilayer body 2.

As shown in FIG. 5, the lateral surface exposed internal electrode 15B includes a lateral surface counter portion 15Ba located in the middle between both lateral surfaces B, and lateral surface extension portions 15Bb extending from the lateral surface counter portion 15Ba toward both lateral surfaces B. The lateral surface counter portion 15Ba has a rectangular or substantially rectangular shape that is slightly smaller than the multilayer body 2, and is spaced apart from both lateral surfaces B in the width direction W by a fixed distance.

The dimension of the lateral surface extension portions 15Bb in the length direction L is smaller than the dimension of the lateral surface counter portion 15Ba in the length direction L. The lateral surface extension portions 15Bb extend toward both lateral surfaces B and are exposed at the lateral surfaces B of the multilayer body 2, and are bonded to the lateral surface external electrodes 4 provided on both lateral surfaces of the multilayer body 2 in the width direction W.

The end surface counter portion 15Aa and the lateral surface counter portion 15Ba are opposed to each other to provide a capacitor portion.

The dielectric layers 14 include a plurality of first dielectric layers 14A and a plurality of second dielectric layers 14B which are alternately laminated. The end surface exposed internal electrode 15A exposed at the end surface C are provided on each of the plurality of first dielectric layers 14A, and the lateral surface exposed internal electrode 15B exposed at a portion of the lateral surface B is provided on each of the plurality of second dielectric layers 14B.

With reference to FIG. 2 and FIG. 3 again, each of the outer layer portions 12 is a dielectric layer provided adjacent to the main surface A of the inner layer portion 11. Each of the outer layer portions 12 is made of the same material as the dielectric layers 14 of the inner layer portion 11.

The end surface external electrodes 3 are provided on both end surfaces C of the multilayer body 2. The end surface extension portions 15Ab of the end surface exposed internal electrodes 15A are connected to the end surface external electrodes 3.

The lateral surface external electrodes 4 are provided on both lateral surfaces B of the multilayer body 2. The lateral surface extension portions 15Bb of the lateral surface exposed internal electrodes 15B are connected to the lateral surface external electrodes 4.

Each of the end surface external electrodes 3 and each of the lateral surface external electrodes 4 include a base electrode layer 31 and a plated layer 32 provided on the base electrode layer 31. The plated layer 32 includes, for example, a Ni (nickel) plated layer 321 provided on the base electrode layer 31 and a Sn (tin) plated layer 322 provided on the Ni plated layer 321. However, the present invention is not limited to such a configuration, and each of the end surface external electrodes 3 and each of the lateral surface external electrodes 4 may have a configuration in which, for example, the base electrode layer 31 is made of Ni, and a Cu plated layer, a Ni plated layer, and a Sn plated layer are sequentially provided thereon.

Each of the end surface external electrodes 3 does not cover only the end surface C. Each of the end surface external electrodes also includes an end surface electrode main surface-side folded portion 3A that covers a portion of the main surface A, and an end surface electrode lateral surface-side folded portion 3B that covers a portion of the lateral surface B. Each of the lateral surface external electrodes 4 does not cover only the lateral surface B. Each of the lateral surface external electrodes 4 also includes a lateral surface electrode main surface-side folded portion 4A that covers a portion of the main surface A. When it is not necessary to distinguish between the end surface electrode main surface-side folded portion 3A and the lateral surface electrode main surface-side folded portion 4A, they are collectively described as folded portions.

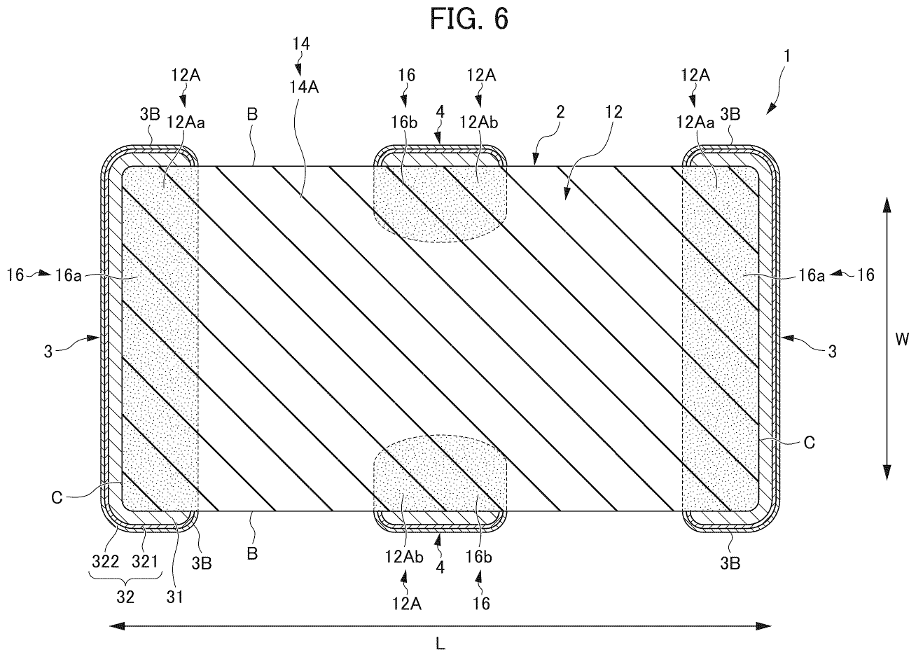

FIG. 6 is a cross-sectional view of an example embodiment of the present invention in which a portion of the outer layer portion 12 in FIG. 1 of the multilayer ceramic capacitor 1 is cut in the IV-IV direction. In each of the outer layer portions 12, end surface-side mixed layers 12Aa are provided in the end surface-side covered portions 16a covered by the end surface electrode main surface-side folded portions 3A of the end surface external electrodes 3. In each of the outer layer portions 12, lateral surface-side mixed layers 12Ab are provided in the lateral surface-side covered portions 16b covered by the lateral surface electrode main surface-side folded portions 4A of the lateral surface external electrodes 4.

In the present specification, when it is not necessary to distinguish between the end surface-side covered portion 16a and the lateral surface-side covered portion 16b, they are collectively referred to as the covered portion 16. When it is not necessary to distinguish between the end surface-side mixed layer 12Aa and the lateral surface-side mixed layer 12Ab, they are collectively referred to as the mixed layer 12A.

The mixed layer 12A includes a dielectric and a metal. The dielectric is the same dielectric as the dielectric of the outer layer portion 12 in the present example embodiment, and the metal is preferably the same metal as the metal of the external electrode, such as Cu or Ni, for example.

The ratio of metal to dielectric in the mixed layer 12A is, for example, about 0.001 mol % or more and about 50 mol % or less. The ratio of metal to dielectric in the mixed layer 12A can be measured, for example, by exposing a cross section of the mixed layer 12A by polishing, performing compositional analysis by EDX (Energy Dispersive X-ray Spectroscopy), and calculating the ratio from quantitative calculation values of each composition obtained from the analysis results.

In the cross section passing through the lamination direction T and the length direction L at the middle in the width direction W shown in FIG. 2, and in the cross section passing through the lamination direction T and the width direction W at the middle in the length direction L shown in FIG. 3, the area occupied by the mixed layer 12A is, for example, about 1% or more and about 99% or less of the total area of the covered portion in the outer layer portion 12. FIGS. 2 and 3 illustrate a case where the area occupied by the mixed layer 12A is, for example, about 50% of the total area of the covered portion in the outer layer portion 12.

In the present specification, “the covered portion in the outer layer portion 12” refers to the end surface-side covered portion 16a, which is a region covered by the end surface electrode main surface-side folded portion 3A of the end surface external electrode 3, and the lateral surface-side covered portion 16b, which is a region covered by the lateral surface electrode main surface-side folded portion 4A of the lateral surface external electrode 4, in the outer layer portion 12 shown in FIGS. 2 and 3.

As shown in FIG. 2, the dimension L1 in the length direction L, which is perpendicular or substantially perpendicular to the end surface C where the end surface external electrode 3 is connected to the end surface exposed internal electrodes 15A, on the main surface A of the end surface electrode main surface-side folded portion 3A of the end surface external electrode 3, is, for example, about 0.05 mm or more and about 0.20 mm or less. The dimension W1 in the width direction W, which is perpendicular or substantially perpendicular to the lateral surface B where the lateral surface external electrode 4 is connected to the lateral surface exposed internal electrodes 15B, on the main surface A of the lateral surface electrode main surface-side folded portion 4A of the lateral surface external electrode 4, is, for example, about 0.05 mm or more and about 0.20 mm or less.

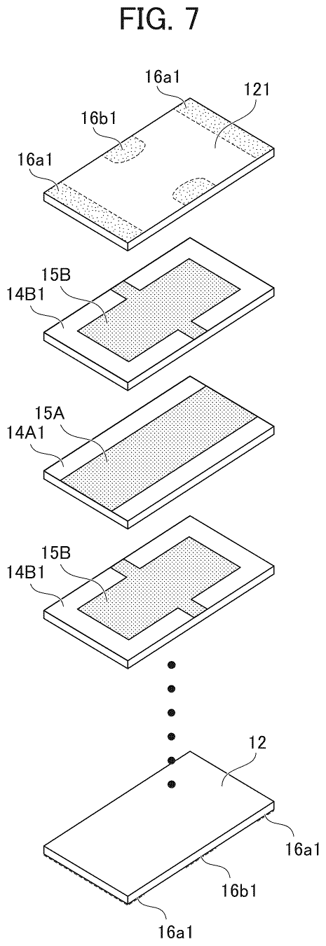

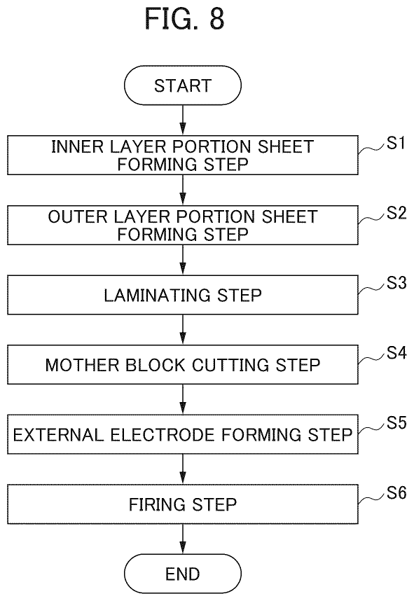

Next, an example of a method of manufacturing the multilayer ceramic capacitor 1 according to an example embodiment of the present invention will be described. FIG. 7 is a diagram explaining the manufacturing steps of the multilayer body 2 in the method of manufacturing the multilayer ceramic capacitor 1 according to the present example embodiment. FIG. 8 is a flowchart explaining the method of manufacturing the multilayer ceramic capacitor 1 according to the present example embodiment.

The end surface exposed internal electrode 15A is formed using an electrically conductive paste on a ceramic green sheet 14A1 defining and functioning as the first dielectric layer 14A. Similarly, the lateral surface exposed internal electrode 15B is formed on a ceramic green sheet 14B1 defining and functioning as the second dielectric layer 14B using an electrically conductive paste.

The ceramic green sheet 14A1 and the ceramic green sheet 14B1 are strip-shaped sheets formed by shaping a ceramic slurry including ceramic powder, a binder, and a solvent into a sheet form on a carrier film using, for example, a die coater, gravure coater, micro gravure coater, or the like.

The end surface exposed internal electrode 15A and the lateral surface exposed internal electrode 15B are formed by, for example, printing such as screen printing, gravure printing, or relief printing.

In the ceramic green sheet defining and functioning as the outer layer portion 12, a small amount of metal powder is printed by, for example, inkjet printing on a portion 16a1 functioning as the end surface-side covered portion 16a and a portion 16b1 defining and functioning as the lateral surface-side covered portion 16b to fabricate a ceramic green sheet 121 for the outer layer portion before lamination.

The ceramic green sheets 14A1 that define and function as the first dielectric layers 14A on which the end surface exposed internal electrodes 15A are provided and the ceramic green sheets 14B1 that define and function as the second dielectric layers 14B on which the lateral surface exposed internal electrodes 15B are provided are alternately laminated.

Subsequently, the ceramic green sheets 121 for manufacturing the outer layer portions are provided on the upper and lower sides with the surfaces on which the metal powder is printed facing outward, and thermocompression bonded to form a mother block.

Next, the mother block is cut and divided in the length direction L and the width direction W to manufacture a plurality of rectangular parallelepiped multilayer bodies 2.

Next, the lateral surface external electrodes 4 are formed on both lateral surfaces B of the multilayer body 2. The lateral surface extension portions 15Bb of the lateral surface exposed internal electrodes 15B are connected to the lateral surface external electrodes 4. The lateral surface external electrodes 4 are formed to cover not only the lateral surfaces B but also portions of the main surfaces A adjacent to the lateral surfaces B. At this time, the portions 16b1 where metal powder is printed in the multilayer body 2 are covered by the lateral surface electrode main surface-side folded portions 4A of the lateral surface external electrodes 4 and define and function as lateral surface-side covered portions 16b.

Then, end surface external electrodes 3 are formed on both end surfaces C of the multilayer body 2. The end surface extension portions 15Ab of the end surface exposed internal electrodes 15A are connected to the end surface external electrodes 3. The end surface external electrodes 3 are formed to cover not only the end surfaces C but also portions of the main surfaces A and portions of lateral surfaces B adjacent to the end surfaces C. At this time, the portions 16a1 where metal powder is printed in the multilayer body 2 are covered by the end surface electrode main surface-side folded portions 3A of the end surface external electrodes 3 and define and function as end surface-side covered portions 16a.

Then, heating is performed for a predetermined time in a nitrogen atmosphere at a set firing temperature. When the end surface external electrodes 3 and the lateral surface external electrodes 4 are fired on the multilayer body 2, the metal powder printed on the end surface-side covered portion 16a and the lateral surface-side covered portion 16b in the outer layer portion ceramic green sheet 121 diffuses into the outer layer portion 12. Thus, the end surface-side mixed layer 12Aa is formed in the end surface-side covered portion 16a, and the lateral surface-side mixed layer 12Ab is formed in the lateral surface-side covered portion 16b, such that the multilayer ceramic capacitor 1 of the present example embodiment is manufactured.

According to the multilayer ceramic capacitor 1 of the present example embodiment, an end surface-side mixed layer 12Aa is formed in an end surface-side covered portion of the outer layer portion 12 covered by the end surface electrode main surface-side folded portion 3A of the end surface external electrode 3. A lateral surface-side mixed layer 12Ab is formed in a lateral surface-side covered portion of the outer layer portion 12 covered by the lateral surface electrode main surface-side folded portion 4A of the lateral surface external electrode 4.

In this way, when the end surface-side mixed layer 12Aa in which the dielectric and metal are mixed is formed, the metal included in the end surface-side mixed layer 12Aa bonds with the metal included in the end surface external electrode 3, and the adhesion strength between the end surface electrode main surface-side folded portion 3A of the end surface external electrode 3 and the outer layer portion 12 is improved, thus improving the strength to resist against external stress of the multilayer ceramic capacitor 1.

When the lateral surface-side mixed layer 12Ab in which the dielectric and metal are mixed is formed, the metal included in the lateral surface-side mixed layer 12Ab bonds with the metal included in the lateral surface external electrode 4, and the adhesion strength between the lateral surface electrode main surface-side folded portion 4A of the lateral surface external electrode 4 and the outer layer portion 12 is improved, thus improving the strength to resist against external stress of the multilayer ceramic capacitor 1.

Accordingly, it is possible to provide the multilayer ceramic capacitor 1 in which the end surface external electrode 3 and the lateral surface external electrode 4 are less likely to peel from the multilayer body 2.

Although example embodiments of the present invention have been described above, the present invention is not limited to the above-described example embodiments, and various changes and modifications thereto can be made.

For example, the above-described example embodiments describe an example of the three-terminal multilayer ceramic capacitor 1 in which the mixed layers 12A are provided at a total of eight locations: four locations on each of the two main surface A sides, namely, the two end surface external electrode 3 sides and the two lateral surface external electrode 4 sides. However, the present invention is not limited thereto, and the mixed layers 12A may be provided on only one of the two main surface A sides. Further, the mixed layers may be provided at some, but not all, of the four locations of the two end surface external electrode 3 sides and the two lateral surface external electrode 4 sides.

Further, instead of the three-terminal multilayer ceramic capacitor 1, a two-terminal multilayer ceramic capacitor may be used. That is, the multilayer ceramic capacitor may include the end surface external electrode 3, the end surface electrode main surface-side folded portion 3A, and the end surface-side mixed layer 12Aa, but may not necessarily include the lateral surface external electrode 4, the lateral surface electrode main surface-side folded portion 4A, and the lateral surface-side mixed layer 12Ab.

Further, although the above-described example embodiments describe a configuration in which the mixed layer 12A is provided in the outer layer portion 12, a mixed layer may be formed in a portion of the dielectric layer 14 of the inner layer portion 11 covered by the folded portion.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion in which a plurality of dielectric layers and a plurality of internal electrodes are alternately laminated, and outer layer portions each on a corresponding one of opposite sides of the inner layer portion in a lamination direction; and
external electrodes each including a main surface-side folded portion on at least one surface of the multilayer body in a direction intersecting the lamination direction and covering a portion of a corresponding one of the outer layer portions; wherein
a mixed layer including a dielectric and a metal is provided in a covered portion of each of the outer layer portions covered by the main surface-side folded portions.

2. The multilayer ceramic capacitor according to claim 1, wherein
the multilayer ceramic capacitor is a three-terminal multilayer ceramic capacitor;
a direction intersecting the lamination direction is defined as a length direction, and a direction intersecting the lamination direction and the length direction is defined as a width direction in the multilayer body;
the plurality of internal electrodes include:
end surface exposed internal electrodes each exposed at end surfaces in the length direction of the multilayer body; and
lateral surface exposed internal electrodes each exposed at lateral surfaces in the width direction of the multilayer body; and
the external electrodes include:
end surface external electrodes each on a corresponding one of the end surfaces of the multilayer body and each connected to the end surface exposed internal electrodes; and
lateral surface external electrodes each on a corresponding one of the lateral surfaces of the multilayer body and each connected to the lateral surface exposed internal electrodes.

3. The multilayer ceramic capacitor according to claim 1, wherein a ratio of the metal to the dielectric in the mixed layer is about 0.001 mol % or more and about 50 mol % or less.

4. The multilayer ceramic capacitor according to claim 1, wherein
a direction intersecting the lamination direction is defined as a length direction, and a direction intersecting the lamination direction and the length direction is defined as a width direction in the multilayer body;
in each of a cross section passing through the lamination direction and the length direction, a cross section passing through the lamination direction and the width direction, and a cross section passing through the length direction and the width direction, an area occupied by the mixed layer is about 1% or more and about 99% or less of a total area of the covered portion.

5. The multilayer ceramic capacitor according to claim 1, wherein
the multilayer ceramic capacitor is a three-terminal multilayer ceramic capacitor;
a direction intersecting the lamination direction is defined as a length direction, and a direction intersecting the lamination direction and the length direction is defined as a width direction in the multilayer body;
the plurality of internal electrodes include:
end surface exposed internal electrodes each exposed at end surfaces opposite in the length direction of the multilayer body; and
lateral surface exposed internal electrodes each exposed at lateral surfaces opposite in the width direction of the multilayer body; and
the external electrodes include:
end surface external electrodes each on a corresponding one of the end surfaces of the multilayer body and each connected to the end surface exposed internal electrodes; and
lateral surface external electrodes each on a corresponding one of the lateral surfaces of the multilayer body and each connected to the lateral surface exposed internal electrodes;
the main surface-side folded portions include:
end surface electrode main surface-side folded portions included in a corresponding one of the end surface external electrodes; and
lateral surface electrode main surface-side folded portions included in a corresponding one of the lateral surface external electrodes;
the covered portions include:
end surface-side covered portions each covered by a corresponding one of the end surface electrode main surface-side folded portions; and
lateral surface-side covered portions each covered by a corresponding one of the lateral surface electrode main surface-side folded portions; and
the mixed layer is provided in each of the end surface-side covered portions and the lateral surface-side covered portions.

6. The multilayer ceramic capacitor according to claim 1, wherein each of the main surface-side folded portions of the external electrodes has a dimension on a corresponding one of the main surfaces in a direction perpendicular or substantially perpendicular to a surface where one of the external electrodes is connected to the plurality of internal electrodes of about 0.05 mm or more and about 0.20 mm or less.

7. The multilayer ceramic capacitor according to claim 1, wherein a dimension in the lamination direction is about 0.10 mm or more and about 0.55 mm or less.

8. The multilayer ceramic capacitor according to claim 1, wherein
a dimension in a length direction intersecting the lamination direction is about 0.10 mm or more and about 0.70 mm or less; and
a dimension in a width direction intersecting the lamination direction and the length direction is about 0.05 mm or more and about 0.40 mm or less.

9. The multilayer ceramic capacitor according to claim 1, wherein each of the external electrodes includes Ni.

10. The multilayer ceramic capacitor according to claim 1, wherein the multilayer ceramic capacitor has a capacitance of about 0.022 μF or more and about 10 μF or less.

11. The multilayer ceramic capacitor according to claim 1, wherein the multilayer ceramic capacitor has an equivalent series inductance of about 65 pH or less at about 100 MHz and about 50 pH or less at about 1 GHz.

12. The multilayer ceramic capacitor according to claim 1, wherein the multilayer body includes rounded corner portions and ridge portions.

13. The multilayer ceramic capacitor according to claim 1, wherein the multilayer body includes dimensions of about 0.09 mm or more and about 0.69 mm or less in the length direction, about 0.04 mm or more and about 0.39 mm or less in the width direction, and about 0.09 mm or more and about 0.54 mm or less in the lamination direction.

14. The multilayer ceramic capacitor according to claim 1, wherein the plurality of dielectric layers include ceramic material.

15. The multilayer ceramic capacitor according to claim 14, wherein the ceramic material includes at least one of Ca, Zr, or Ti.

16. The multilayer ceramic capacitor according to claim 14, wherein the ceramic material has a perovskite structure including Ca and Zr.

17. The multilayer ceramic capacitor according to claim 14, wherein the ceramic material includes barium titanate and calcium zirconate.

18. The multilayer ceramic capacitor according to claim 14, wherein the ceramic material includes Ca, Zr, and Ti.

19. The multilayer ceramic capacitor according to claim 1, wherein the plurality of internal electrodes include Ni, Cu, Ag, Pd, an Ag—Pd alloy, or Au.

20. The multilayer ceramic capacitor according to claim 1, wherein each of the external electrodes includes a base electrode layer and a plated layer.
